(19) United States
(12) Patent Application Publication
(10) Pub. No.: US 2014/0177908 A1
(43) Pub. Date: Jun. 26, 2014

(54) SYSTEM OF OBJECT DETECTION

(71) Applicants: NCKU RESEARCH AND DEVELOPMENT FOUNDATION, Tainan City (TW); HIMAX TECHNOLOGIES LIMITED, Tainan City (TW)

(72) Inventors: Ming-Der SHIEH, Tainan City (TW); Der-Wei YANG, Tainan City (TW); Tzung-Ren WANG, Tainan City (TW)

(73) Assignees: Himax Technologies Limited, Tainan City (TW); NCKU Research and Development Foundation, Tainan City (TW)

(21) Appl. No.: 13/727,455

(22) Filed: Dec. 26, 2012

(51) Int. Cl. G06K 9/00

(52) U.S. Cl. CPC G06K 9/00228
USPC 382/103

(57) ABSTRACT

In a system of object detection, a color detector detects at least one image region in an input image having a color specifically pertinent to the object under detection, thereby obtaining an object width. A dynamic down-sampling unit adaptively performs down-sampling on the detected image region using a generated down-sampling factor according to the object width. An image feature generator receives the down-sampled image and accordingly generates image features for describing the object under detection, and a cascade of classifiers then operates on the image features.

### BACKGROUND OF THE INVENTION

1. Field of the Invention

The present invention generally relates to a system of object detection, and more particularly to a system of face detection.

2. Description of Related Art

Face detection is a technology for determining locations and sizes of human faces in an image. The face detection may be regarded as a specific field of object-class detection for determining the locations and sizes of all objects in an image that belong to a given class.

Conventional face defection systems disadvantageously suffer from low accuracy due to intensity variation, such that the systems sometimes fail to detect the face with bright intensity. Moreover, as the size of a processor for performing face detection is generally fixed in size, which is smaller than the size of an image under processed, it is thus required to down-sample the image before detecting the face. However, the fixed-size processor need deal with faces under detection with different sizes, the conventional face detection systems therefore either perform different down-sampled masks sequentially to result in a low frame rate or store different scales of down-sampled images that are then processed in parallel to result in large storage demand. It has been disclosed in prior art a boosting algorithm for object detection, using cascade structure. Nevertheless, the cascade structure used in the conventional face detection systems is complex in architecture, requires large amount of storage, and has large latency.

For the foregoing reasons, a need has arisen to propose a novel system of object detection to overcome deficiencies of the conventional face detection systems.

### SUMMARY OF THE INVENTION

In view of the foregoing, it is an object of the embodiment of the present invention to provide a system of object detection that has light variation tolerability, reduction in architecture complexity and/or increased processing speed.

According to one embodiment, a system of object detection includes a color detector, a dynamic down-sampling unit, an image feature generator and a cascade of classifiers. The color detector is operable to receive an input image and configured to detect at least one image region in the input image having a color specifically pertinent to the object under detection, thereby obtaining an object width. The dynamic down-sampling unit is configured to adaptively generate a proper down-sampling factor according to the object width, and perform down-sampling on the detected image region using the generated down-sampling factor, thereby generating a down-sampled image. The image feature generator is operable to receive the down-sampled image, and accordingly configured to generate image features for describing the object under detection. The cascade of classifiers is configured to operate on the image features.

### BRIEF DESCRIPTION OF THE DRAWINGS

FIG. 1 shows a block diagram illustrating a system of object detection according to one embodiment of the present invention;

FIG. 2 shows a flow diagram illustrating the intensity-variation tolerable skin color detection according to the embodiment;

FIGS. 3A to 3D show some exemplary Haar features;

FIG. 4A shows a 3×3 array integral image example;

FIG. 4B shows a systolic array associated with FIG. 4A;

FIG. 4C shows Haar feature generation according to the integral image of FIG. 4A; and

FIG. 5 shows a reversed systolic array according to the embodiment.

### DETAILED DESCRIPTION OF THE INVENTION

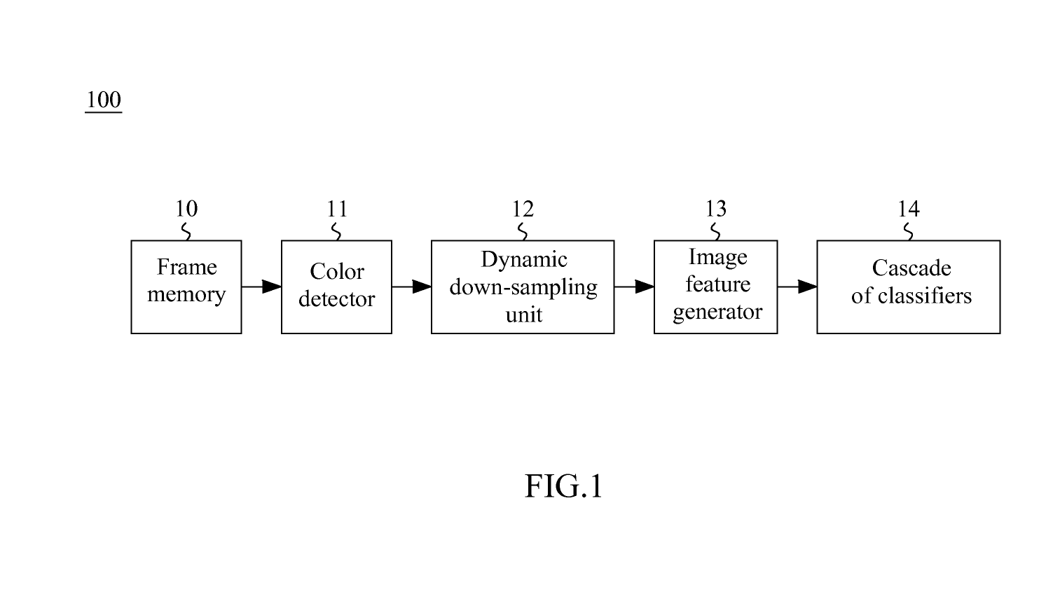

FIG. 1 shows a block diagram illustrating a system of object detection 100 according to one embodiment of the present invention. Although face (particularly human face) detection is illustrated in the embodiment, it is noted that the system 100 may be well adapted to detect an object other than the face.

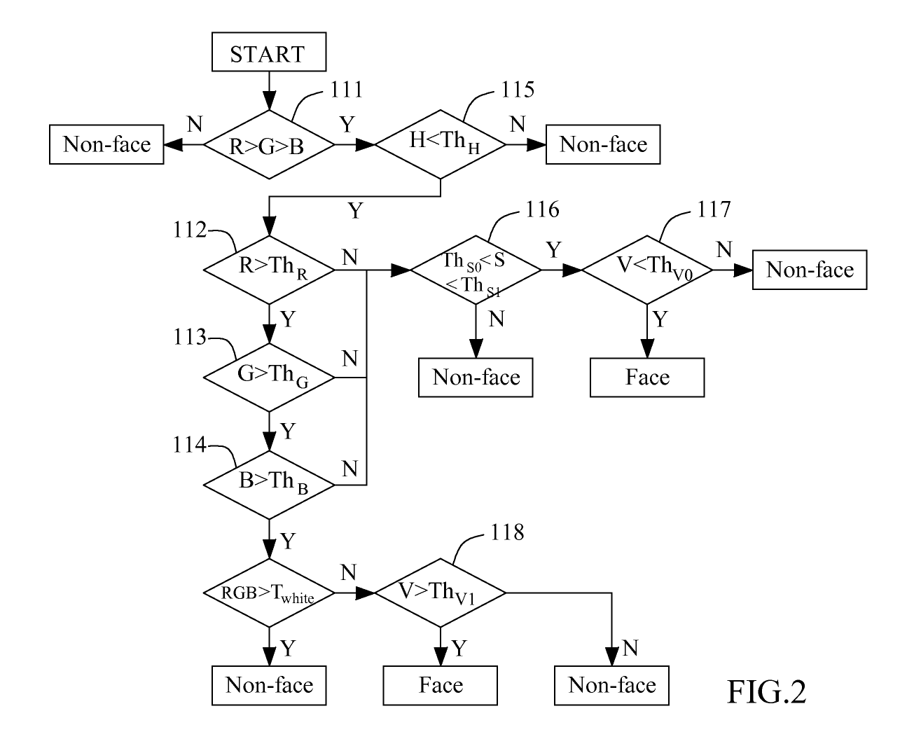

The system 100 includes a color detector 11 that is operable to receive an input image, for example, stored in a frame memory 10, and the color detector 11 is then configured to detect at least one image region in the input image having a color specifically pertinent to the object under detection. For example, in the specific embodiment, the color detector 11 is a skin color detector that is utilized, to detect at least one image region having a skin color. In view of the fact that conventional face detection systems suffer from low accuracy due to intensity variation in the face region, the embodiment, according to one aspect of the invention, provides an intensity-variation (or light-variation) tolerable skin color detection scheme in the color detector 11. Specifically speaking, the color detector 11 performs in both RGB (red, green and blue) color space and device-independent color space such as HSV (hue, saturation and brightness value) color space. FIG. 2 shows a flow diagram illustrating the intensity-variation tolerable skin color detection according to the embodiment. In the flow as illustrated in FIG. 2, in step 111, it is one sufficient condition for skin color that a red component (R) should be greater than a green component (G), which is further greater than a blue component (B). The red component, the green component and the blue component are respectively compared, in steps 112, 113 and 114, with corresponding threshold values Th_{R}, Th_{G}, and Th_{B}. Based on the results of step 111-114, a hue component (H), a saturation component (S) and/or a brightness value component (V) are compared, in steps 115-118, with corresponding threshold values. Compared with conventional face detection systems that are performed in a single color space such as RGB color space, the present embodiment is capable of detecting skin color no matter what the intensity. In addition to the detected image region, the color detector 11 of the embodiment also obtains an object width, e.g., a face width, which will be used later.

Referring again to FIG. 1, the system 100 includes a dynamic down-sampling unit 12, which is configured to adaptively generate a proper down-sampling factor according to the object width (e.g., face width) obtained from the color detector 11. Subsequently, the dynamic down-sampling unit 12 performs down-sampling on the detected image region using the generated down-sampling factor, therefore generating a down-sampled image. Compared with the conventional face detection system that either performs different down-sampled masks sequentially to result in a low frame rate or stores different scales of down-sampled images that are then processed in parallel to result in large storage demand, the present embodiment achieves a single scan-line scheme with dynamic down-sampling that can adaptively deal with different object sizes (e.g., face sizes) with respect to fixed-size later stage(s).

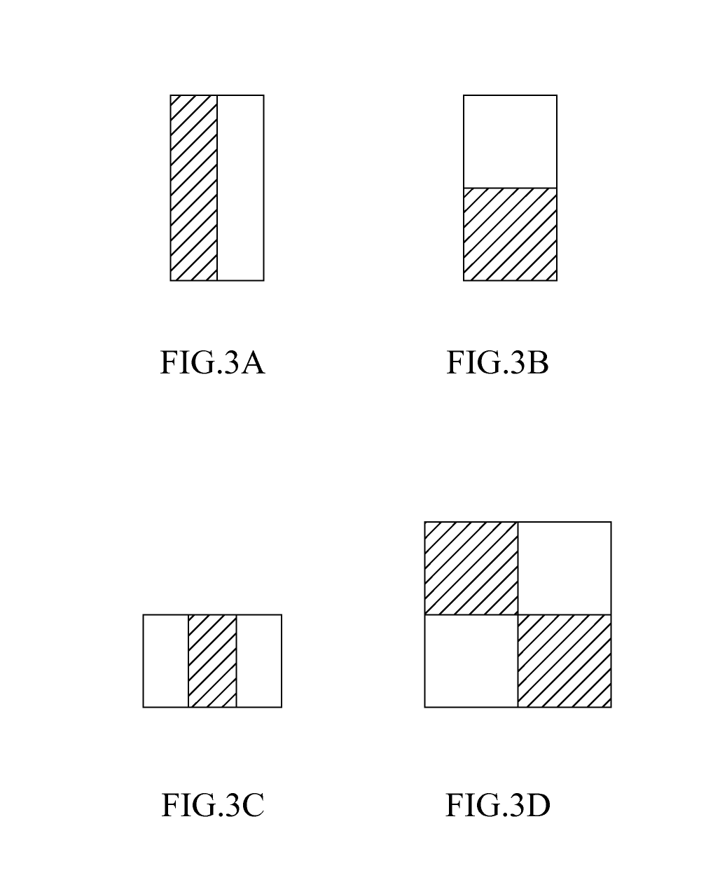

Still referring to FIG. 1, the system 100 includes an image feature generator 13 that is operable to receive the down-sampled image, and is then configured to generate image features for describing the object under detection. In the embodiment, Haar features are obtained as the image features for accurately describing the object (e.g., the face). The details of Haar features may be referred to, for example, P. Viola and M. Jones, “Robust real-time object detection,” Int. J. of Computer Vision, vol. 57, no. 2, pp. 137-154, 2001, disclosure of which is incorporated herein by reference. FIGS. 3A to 3D show some exemplary Haar features, in which two-rectangle features are shown in FIGS. 3A and 3B, a three-rectangle feature is shown in FIG. 3C, and a four-rectangle feature is shown in FIG. 3D.

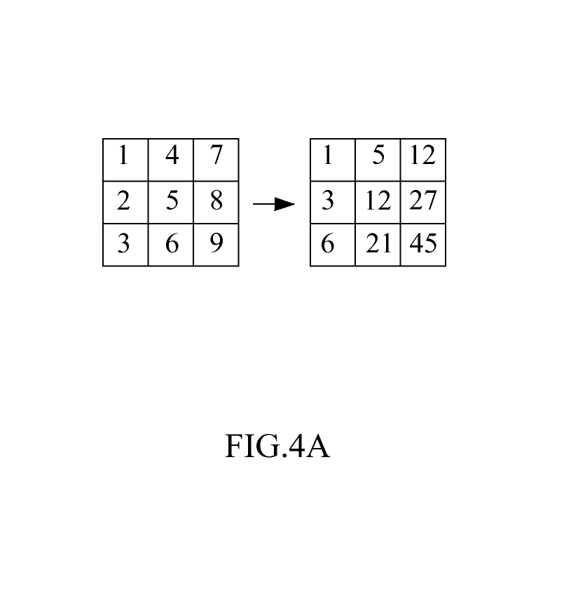

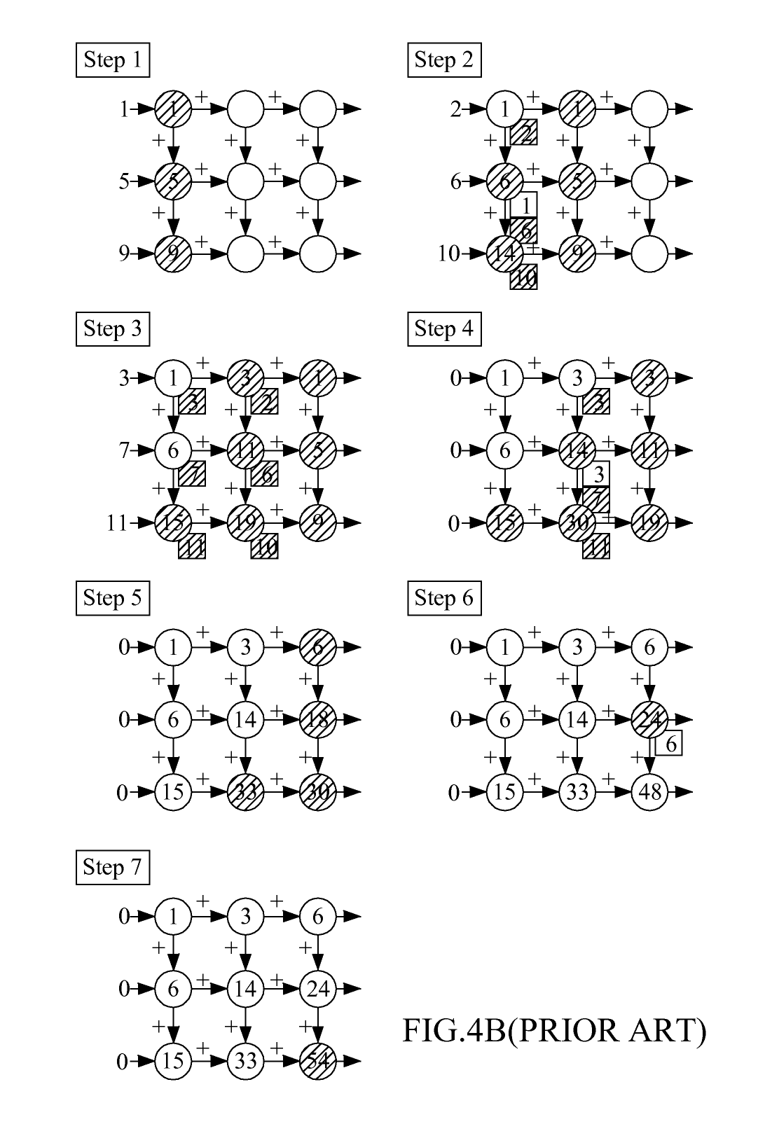

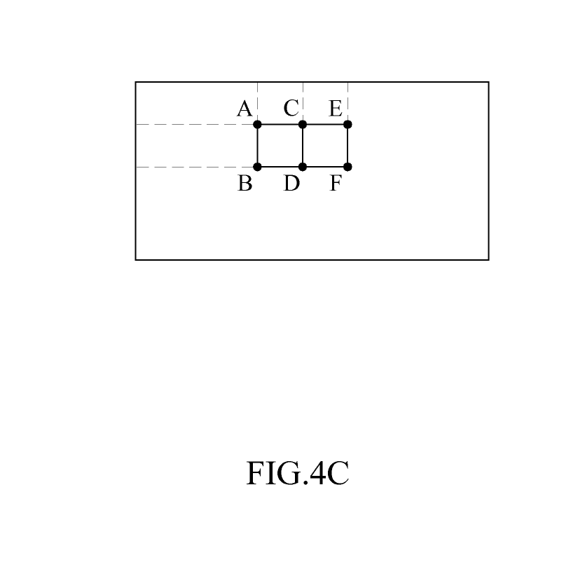

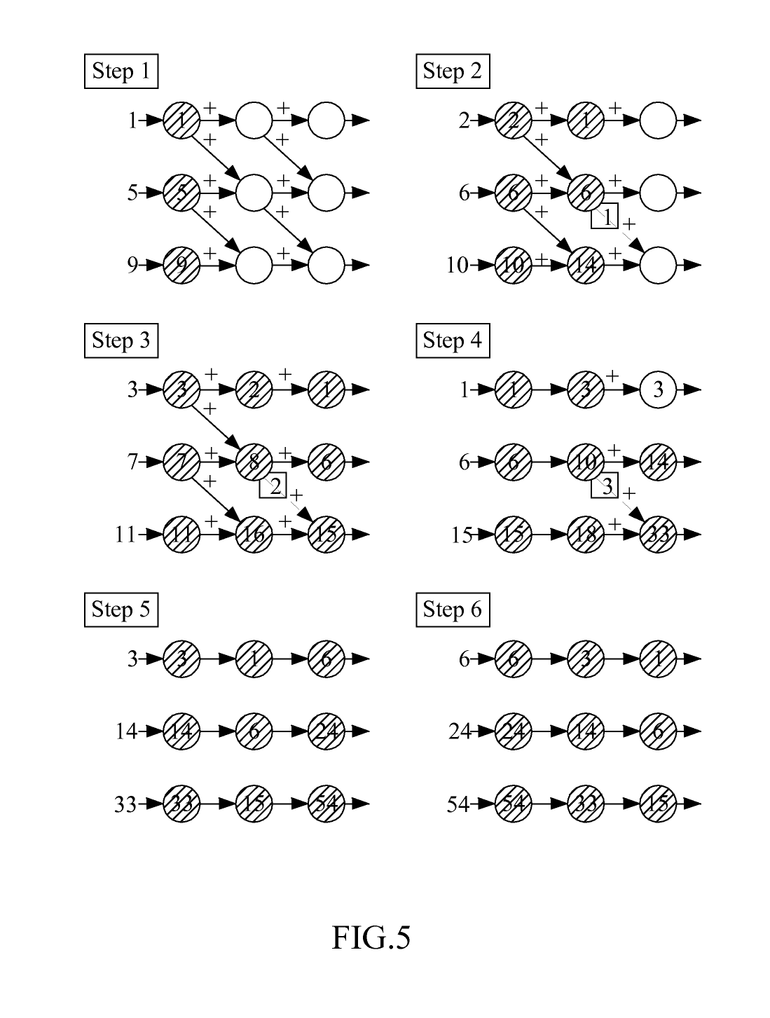

The image feature generator 13 of the embodiment may include a systolic array composed of matrix-like rows of data processing units, which are utilized to generate an integral image, which facilitates fast generation of Haar features by eliminating computational redundancy when the rectangular features are overlapping. The details of the integral image may be referred to, for example, P. Viola and M. Jones mentioned above. FIG. 4A shows a 3×3 array integral image example, FIG. 4B shows an associated systolic array, and FIG. 4C shows Haar feature generation according to the integral image. According to one aspect of the embodiment, the image feature generator 13 adopts a reversed systolic array as exemplified in FIG. 5. Compared with the conventional systolic array (FIG. 4B), the value of each node (that correspond to a pixel) is added to a succeeding-column node of the same row, and is also added to a succeeding-column node of the next row (in stead of being added to the same-column node of the next row as shown in FIG. 4B. According to the structure of FIG. 5, the present embodiment may reduce storage, system complexity and increase processing speed, compared with the conventional systolic array. The structure of FIG. 5 is called reversed, systolic array for the reason that the calculated values are disposed at nodes in a reversed or mirrored order, compared with that in FIG. 4B.

Referring back to FIG. 1, the system 100 includes a cascade of classifiers 14 configured to operate on the Haar features (generated from the image feature generator 13). The cascade of classifiers 14 allows background regions of the image to be quickly discarded while spending more computation on promising object-like regions, thereby dramatically increasing the speed of the object detection. The details of the cascade of classifiers 14 may be referred to, for example, P. Viola and M. Jones mentioned above.

As discussed above, the system 100 uses a color detector 11, which accompanies the cascade of classifiers 14 to result in a hybrid structure. Accordingly, the hybrid structure not only improves poor false positive rate in color based face detection, but also reduce complexity in the cascade of classifiers 14.

Although specific embodiments have been illustrated and described, it will be appreciated by those skilled in the art that various modifications may be made without departing from the scope of the present invention, which is intended to be limited solely by the appended claims.

What is claimed is:

1. A system of object detection, comprising:
a color detector operable to receive an input image and configured to detect at least one image region in the input image having a color specifically pertinent to the object under detection, thereby obtaining an object width;
a dynamic down-sampling unit configured to adaptively generate a proper down-sampling factor according to the object width, and perform down-sampling on the detected image region using the generated down-sampling factor, thereby generating a down-sampled image;
an image feature generator operable to receive the down-sampled image, and accordingly configured to generate image features for describing the object under detection; and
a cascade of classifiers configured to operate on the image features.

2. The system of claim 1, wherein the object comprises a face.

3. The system of claim 1, further comprising a frame memory configured to store the input image.

4. The system of claim 1, wherein the color specifically pertinent to the object comprises a skin color.

5. The system of claim 1, wherein the color detector performs in RGB (red, green and blue) color space and device-independent color space.

6. The system of claim 5, wherein, the device-independent color space comprises HSV (hue, saturation, and brightness value) color space.

7. The system of claim 6, wherein the color detector performs the following steps:
determining whether a red component in the RGB color space is greater than a green component in the RGB color space, which is further greater than a blue component in the RGB color space;
comparing the red component, the green component and/or the blue component respectively with corresponding threshold values; and
comparing a hue component, a saturation component and/or a brightness value component in the HSV color space with corresponding threshold values.

8. The system of claim 1, wherein the dynamic down-sampling unit performs down-sampling by adaptively dealing with different object sizes according to the object width.

9. The system of claim 1, wherein the image features comprise Haar features.

10. The system of claim 9, wherein the image feature generator comprises a systolic array composed of matrix-like rows of data processing units, which are configured to generate an integral image, which facilitates generation of Haar features.

11. The system of claim 10, wherein the image feature generator comprises a reversed systolic array, in which a value of each node corresponding to a pixel is added to a succeeding-column node of the same row, and is also added to a succeeding-column node of the next row.
